(19) United States
(12) Patent Application Publication
(10) Pub. No.: US 2004/0208492 A1
(43) Pub. Date: Oct. 21, 2004

(54) Video/audio data recording/reproducing apparatus

(75) Inventor: Masaki Oguro, Gyunggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronic Co., Ltd., Suwon-city (KR)

(21) Appl. No.: 10/721,507

(22) Filed: Nov. 26, 2003

Related U.S. Application Data
(60) Provisional application No. 60/464,111, filed on Apr. 21, 2003.

(30) Foreign Application Priority Data
Jun. 1, 2003 (KR) P2003-656
Aug. 1, 2003 (KR) P2003-1166

(51) Int. Cl. H04N 5/76; H04N 5/225

(52) U.S. Cl. 386/117; 386/125; 348/207.99

(57) ABSTRACT

A video/audio data recording/reproducing apparatus includes a body having a control unit, a data recording medium and a battery, a camera unit provided at a side of the body, a display unit variable in position with respect to the body, and an audio data processing unit. A control unit and a micro-compact hard disc drive used as a main data recording medium, interface features of various product units provided in the apparatus, such as a digital camcorder, a digital still camera, an MP3 player and a voice recorder, thereby providing a compact-sized and portable video/audio recording/reproducing apparatus realizing various functions.

### CROSS-REFERENCE TO RELATED APPLICATIONS

This application claims priority under 35 USC 119 from U.S. Provisional Application Ser. No. 60/464,111 entitled “COMPLEX VIDEO/AUDIO DATA RECORDING/REPRODUCING APPARATUS,” filed on Apr. 21, 2003 in the United States Patent and Trademark Office, and from Korean Patent Application nos. 2003-656, filed Jan. 6, 2003, and 2003-1166, filed Jan. 8, 2003, in the Korean Intellectual Property Office, all of the contents of which are hereby fully incorporated herein by reference.

### BACKGROUND OF THE INVENTION

1. Field of the Invention

The present invention generally relates to a video/audio data recording/reproducing apparatus, and more particularly, it relates to a video/audio data recording/reproducing apparatus comprising multiple product units, such as a digital camcorder, a digital still camera, an MP3 player, a voice recorder, etc., which are integrated into one package.

2. Description of the Related Art

Generally, a digital still camera (DSC) converts an image incident through a lens into a digital signal, and stores it (i.e., stores a digital image). Such a digital still camera is highly compatible with a personal computer (PC), the digital image is easy to edit and adjust, and easy to transfer the digital images to the external computers connected to the DSC. Also, the digital still camera, having the same structure as a general camera, is easy to carry. The digital still camera is provided with a lens device, a memory device, a signal converting device and a display device. Due to a limited image recording capacity, the digital still camera is usually used in taking pictures of still objects. Although the digital still cameras can take motion pictures up to a certain limited volume, taking motion pictures for a long period of time is almost impossible. Particularly, the inability to record/reproduce sound during recording/reproducing of motion pictures limits the digital still cameras from recording/reproducing motion pictures.

Meanwhile, a camcorder is a widely-known image recording/reproducing device which can record/reproduce motion pictures including sound. The camcorder is provided with a lens device, a signal converting device, a deck device for recording/reproducing images being taken, and a display device. The camcorder usually uses a cassette tape as a recording medium to record images as a motion picture and can record over 1 hour of motion pictures. Further, the camcorder is provided with a microphone device and a speaker device for audio input/output. The camcorder is also provided with a function of taking still pictures, however, at a lower picture quality as compared to the digital still camera. Also, since the camcorder has more complex functions that subsequently require complex structure, it is relatively bulkier and more expensive than the digital still camera.

Accordingly, many people are buying the digital still camera and the camcorder together, because one lacks the function or quality of the other. This causes a financial burden to the customers. Besides, users have to carry the digital still cameras and the camcorders together, which is quite inconvenient.

Accordingly, there is an increased need for a new type of a video/audio data recording/reproducing apparatus capable of multiple functions.

Further, as the conventional complex video/audio data recording/reproducing apparatus is relatively bulky and has a small recording capacity, it is somewhat inconvenient to effectively/efficiently use all of the complex functions.

### SUMMARY OF THE INVENTION

Accordingly, the present invention provides a complex video/audio data recording/reproducing apparatus efficiently providing various digital image/audio signal processing functions, thereby serving as various digital signal processing apparatuses, such as a camcorder, a digital still camera, a voice recorder, an MP3 player, a data storage, a video storage/player, and a web camera and many others in various fields.

According to an aspect of the present invention, the present invention provides a complex video/audio data recording/reproducing apparatus embodied as a package of multiple product units including basic image processors, such as a camcorder and a digital still camera, and audio/advanced digital technology processors, such as an MP3 player and a voice recorder.

According to an aspect of the present invention, a controller manages, such as process and output, data for the various product units to efficiently perform various data processing functions in a complex video/audio data recording/reproducing apparatus. In particular, the controller digitizes an input image signal from a camera lens for processing in the complex video/audio data recording/reproducing apparatus, digitizes an input image signal from an external computing device, such as a TV, processes input audio signals, processes input data, outputs data (e.g., output image, audio, etc., signals), and reads/writes the data from/to various recording media according to a function/application.

According to an aspect of the invention, the apparatus comprises a hard disc drive for input video data, which are usually multi-dimensional and thus have huge volume of information, thereby requiring more storage and more advanced data compressions, and for input audio data that may require more storage because of function/application, such as a user music.

Additional aspects and advantages of the invention will be set forth in part in the description which follows and, in part, will be obvious from the description, or may be learned by practice of the invention.

The present invention may be achieved by a complex video/audio data recording/reproducing apparatus, comprising a single chip controller controlling processing by various function units as a digital camcorder, a digital still camera, a video recorder/reproducer, a data storage, an MP3 player and a voice recorder, and a micro-compact hard disc drive as a main data recording medium storing data of the various function units.

According to an aspect of the invention, the apparatus further comprises a body including the single chip controller and the micro-compact hard disk drive, and a station communicatively receiving the body and providing a plurality of transmission/reception terminals allowing data transmission/reception between the body and external computing devices.

The present invention may be also achieved by a controller controlling data processing among various data processors implementing various functions of a complex video/audio data recording/reproducing apparatus, the controller comprising a system bus, a multiplexer/system resource controller in communication with the system bus and outputting image signals, a motion picture experts group 4 compressor/decompressor in communication with the system bus and compressing/decompressing data of the function units, a data recording medium interface in communication with the system bus and reading/writing data from/to a memory unit and the micro-compact hard disc drive, a universal serial bus interface in communication with the system bus and receiving/transmitting the data of the function units, a video processor in communication with the system bus and processing image signals input through the digital camcorder and still camera function units or input through an input terminal, an audio encoder/decoder in communication with the system bus and processing input/output audio signals for the MP3 player and the voice recorder, and a central processing unit controlling the controller via the system bus.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a perspective view of a camera rear area of the video/audio data recording/reproducing apparatus, according to an embodiment of the present invention;

FIG. 2 is a perspective view of a camera front area of the apparatus shown in FIG. 1;

FIG. 3 is an exploded perspective view of the video/audio data recording/reproducing apparatus shown in FIG. 1.

FIG. 4 is a more detailed perspective view of the video/audio data recording/reproducing apparatus shown in FIG. 1;

FIGS. 5A and 5B are schematic perspective views showing use of a display unit of the complex video/audio data recording/reproducing apparatus shown in FIG. 1, according to an embodiment of the present invention;

FIG. 6 is a perspective appearance view of a video/audio data recording/reproducing apparatus, according to another embodiment of the present invention;

FIG. 7 is a rear perspective view of the apparatus shown in FIG. 6;

FIG. 8 is a functional block diagram of the video/audio data recording/reproducing apparatuses shown in FIGS. 1 and 6, according to an embodiment of the present invention; and

FIG. 9 is a functional block diagram of the control unit shown in FIG. 8.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below to explain the present invention by referring to the figures.

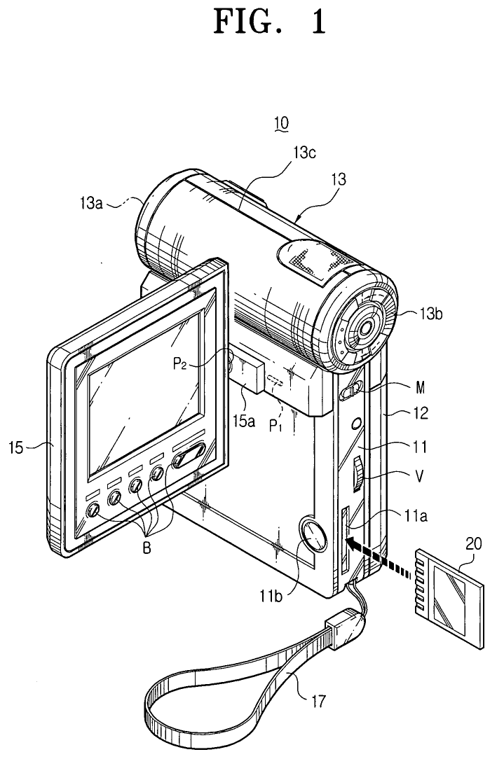

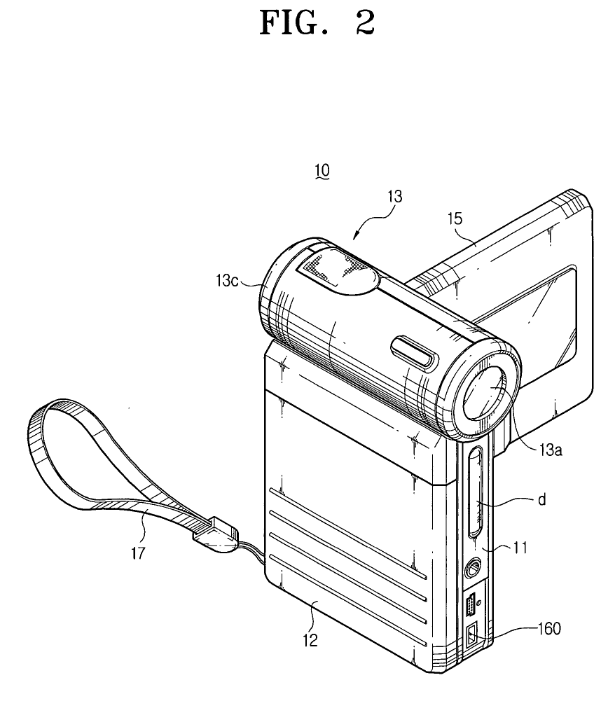

Referring to FIGS. 1 to 4, a video/audio data recording/reproducing apparatus 10, according to an embodiment of the present invention, comprises a body 11, a camera unit 13, a display unit 15, and a battery 30.

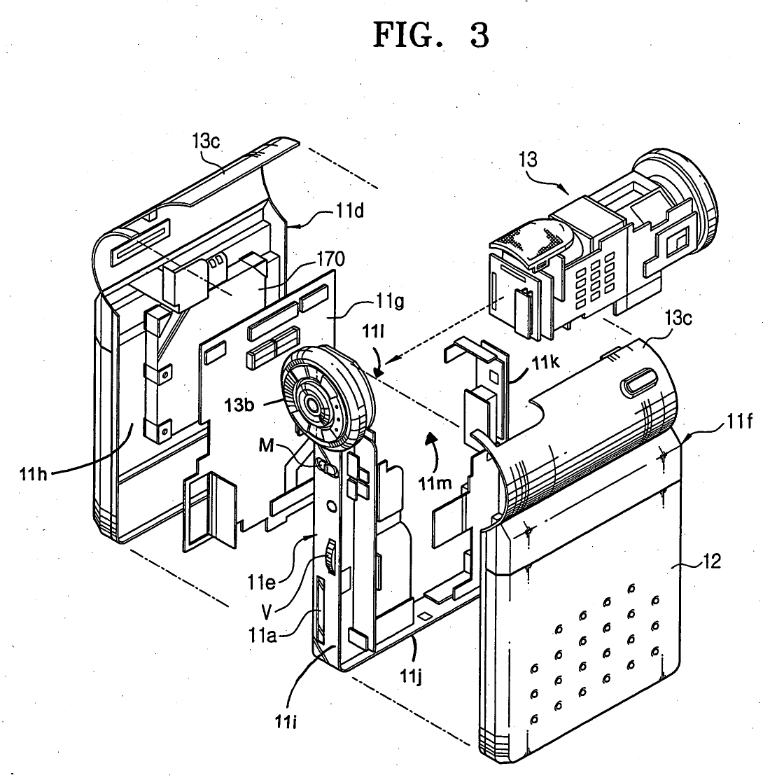

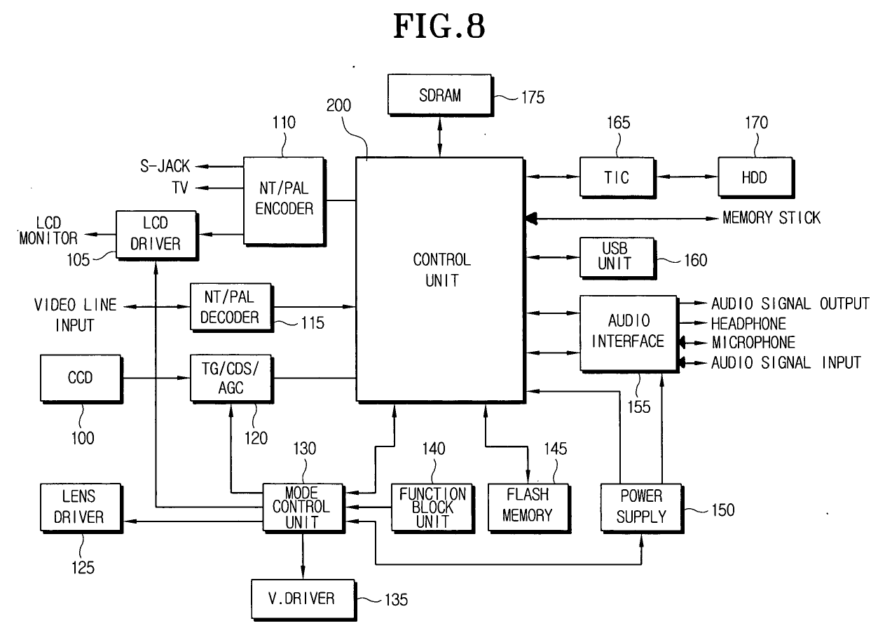

In FIG. 3, the body 11 comprises first, middle, and second housings 11d, 11e, and 11f to receive a hard disc drive 170 as a main data recording medium, the camera unit 13, the battery 30, and a circuit board 11g that, typically, embodies processing functions of the audio/video recording/reproducing apparatus 10 (FIG. 8). Typically, the first body housing 11d has a receiving area 11h to receive/accommodate the hard disc drive 170 as the main data recording medium. Typically, a 1-inch compact hard disc drive 170 is used as the main data recording medium, although the present invention is not limited to such a 1-inch compact hard disc drive configuration and the hard disc drive 170 may be any type of compact large capacity non-volatile data storage that can be accommodated in the first body housing 11d.

In FIG. 3, according to an aspect of the invention, the first body housing 11d and/or the middle body housing 11e, together, or individually, can receive the circuit board 11g (all or a portion thereof, as the case may be). Further, a plurality of operation/manipulation buttons/housings 13b, M, and V may be provided on the body 11 and in communication (directly or indirectly) with the circuit board 11g to control the processing functions of the apparatus 10 (FIG. 8). Typically, the operation buttons 13b, M, and V are provided on an exposed side of the middle body housing 11e and will be described in more detail below.

The first and second main body housings 11d and 11f are formed in the same direction and are in a parallel relation to each other. Each of the first and second housings 11d and 11f has a receiving area 11h and 11c, respectively, in which, typically, one receiving area (11h) faces an interior area of the apparatus 10 and the other receiving area (11c) faces outside when the first and second body housings 11d and 11f are joined together to generally form two sides of the apparatus 10. Accordingly, when the first and second body housings 11d and 11f are joined, a single interior receiving area is formed that is at least the same size of one of the receiving areas of the body housings 11d and 11f. One of the receiving areas of the 11d and 11f has a size to receive the hard disc drive 170. The first and second body housings 11d and 11f also receive therebetween (support in between) the middle body housing 11e and the camera unit 13 as shown in FIG. 3.

The middle body housing 11e tracks the shape of the housings 11d and 11f, and, typically, is rectangular with two vertical surfaces 11i and 11k, and two horizontal surfaces 11j and 11L, and with a through opening (a passage) 11m. Three of the four surfaces 11i, 11j, and 11k of the middle body housing 11e can be exposed to form three sides of the apparatus 10 or covered by the first and second body housing 11d and 11f, when the middle body housing 11e is in between the first and second body housings 11d and 11f. The top horizontal surface 11L of the middle body housing 11e supports the camera unit 13. Typically, the middle body housing 11e has the through opening including support surfaces (or any other known mounting technique) provided therein to mount therein or receive therein (as the case may be) the circuit board 11g. Further, typically, the top horizontal side 11L of the middle body housing 11e is open with the other three surfaces 11i, 11j and 11k at right angles with respect to each other to form a U shape, as shown in FIG. 3. Typically, the open top 11L has support surfaces on which the camera unit 13 is seated. Typically, the three surfaces of the middle housing 11e are exposed to accommodate various operation/manipulation buttons/housings (e.g., 13b, M, V) slots (e.g., 11a), interface ports (e.g., d, 160, etc.). Increasing the surface size (width) of the middle body housing 11e when placed between the first and second body housing 11d and 11f (i.e., increasing the exposure of the side surfaces 11i, 11j, 11k, and 11L of the middle body housing 11e), increases the single interior receiving area of the apparatus 10 comprising the first body housing receiving area 11h and the middle body housing opening 11m. With the body housing structures 11d, 11e, and 11f, the body 11 can be made more compact-sized while having a higher data storage capacity by accommodating the hard disc drive 170 (i.e., the apparatus 10 is not being bulky and has a high non-volatile data storage capacity).

Further, as shown in FIG. 1, typically, in the body 11, a slot 11a is formed (i.e., at an exposed side of the middle body housing 11e), to which a removable storage 20, such as a smart card or a memory stick, is connected as a supplementary data recording medium. Beside the above-mentioned storage media, other types of storages, such as flash memory 145 (FIG. 8) or SDRAM 175 (FIG. 8) can additionally be used, which will be described later. In FIG. 1, a window 11b is provided through which a user can check whether the removable storage 20 is connected to the body 11 via the slot 11a. Typically, the user uses a band 17 to hold the body 11 stably during shooting (i.e., recording). Typically, function manipulation buttons B, which are substantially same as those on a conventional digital camcorder, are provided on the display unit 15. The button M on the middle body housing 11d is a mode shifting switch through which functions are shifted and selected, for example, from among a camcorder function, a digital still camera function, and an MP3 player function. The dial switch V is provided for making adjustments, for example, to sound volume.

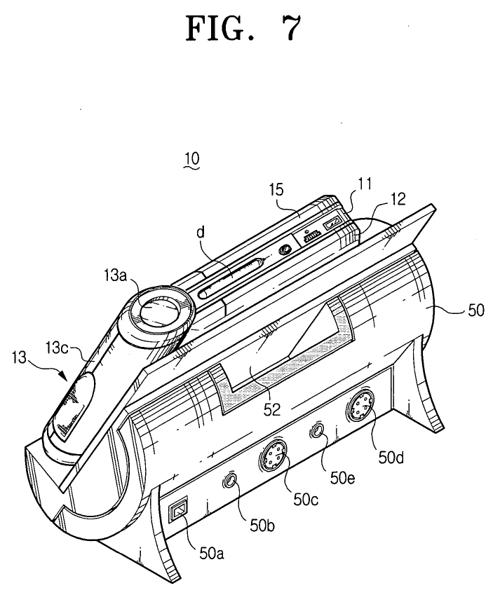

Typically, the camera unit 13 comprises an optical system, a lens 13a, zoom buttons 13b (zoom button housing), a CCD 100 (FIG. 7) for photoelectrically converting an optical image formed by the optical system, and an outer casing 13c, which is formed by a pair of integral casing areas on a top portion of the first and second body housings 11d and 11f. According to the present invention, the outer casing 13c of the camera unit 13 is external by being integrally formed on the sides of the body 11 (i.e., integrally formed on the first and second body housings 11d and 11f) and externally covers the camera unit 13. Typically, the integral casing areas 13c are concave. According to an aspect of the invention, the operation buttons 13b as a zoom button housing 13b can be formed exposed on a top portion of the vertical side surface 11i of the middle body housing 11e to be at the same horizontal axis of the camera unit 13 and at a position opposite to the lens 13a, or can be an integral part of the camera unit 13 opposite of the lens 13a when the camera unit 13 rests on the top horizontal surface 11L of the middle body housing 11e, as shown in FIG. 3. Typically, the zoom button housing 13b is circular and accommodated/received in the concave integral casing 13c of the first and second body housings 11d and 11f, respectively. The zoom buttons 13b can change a focal length of the lens 13a, and, typically, the zoom button housing is resiliently supported by the external outer casing 13c (i.e., supported by the first and middle body housings 11d and 11f by holding therebetween the camera unit 13). Typically, the zoom button 13b slid along a circular-arc guide rail in the direction arrowed in FIG. 1.

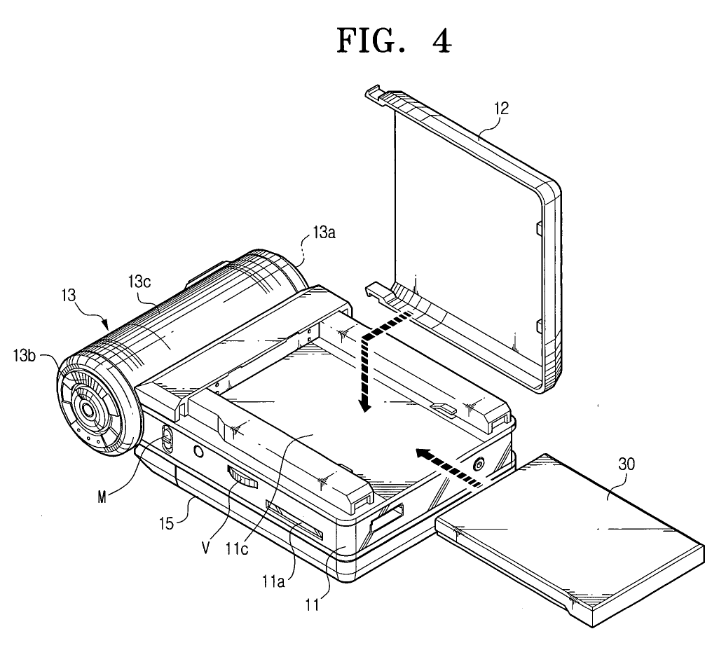

FIG. 4 is a more detailed perspective view of FIG. 1. In particular, typically, on a side of the body 11 (i.e., on one of the first and second housing bodies 11d or 11f) is formed the receiving area 11c as a battery seat 11c on/from which the battery 30 is mounted and dismounted. Also, typically, on the battery seat side of the body 11 is formed a rear side cover 12, which is removably mounted on the battery seat 11c to protect the battery 30 seated on the battery seat 11c.

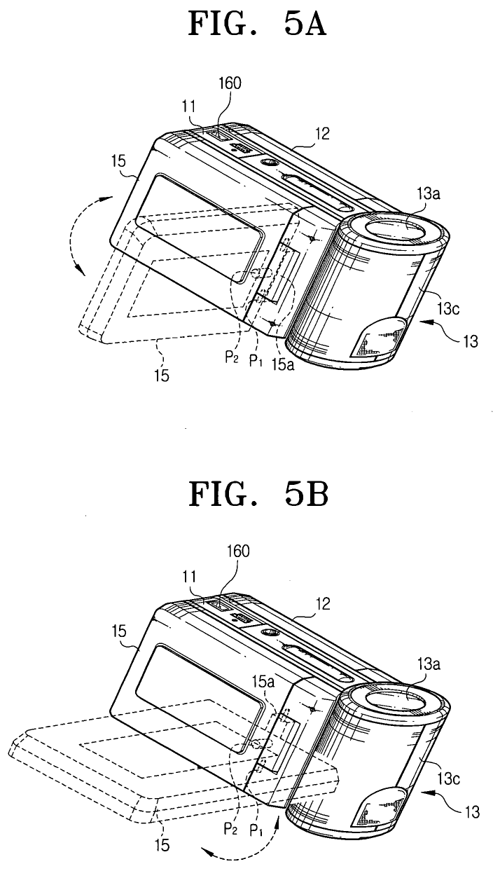

As shown in FIGS. 5A and 5B, the display unit 15 is connected to the body 11 in a manner such that the display unit 15 rotates with respect to the body 11 about a pair of rotary axes P1, P2, which are in a perpendicular relation. Therefore, the display unit 15 is supported by a rotary block 15a which is foldable with respect to the body 11 so that the display unit 15 can be freely folded with respect to the body 11 while it is also freely rotated with respect to the rotary block 15a. The display unit 15 may use an LCD monitor, and it can function as a viewfinder displaying the object of the shooting, or it can enable viewing one of input video data, pre-stored video data of the compact hard disc drive 170, and external video data received from external data processors during reproduction. As the display unit 15 is rotatably mounted on the body 11 to be rotated on the plural rotary axes P1 and P2, the user holding the body 11 can view, for example, the videos being reproduced through the display unit 15 at various positions.

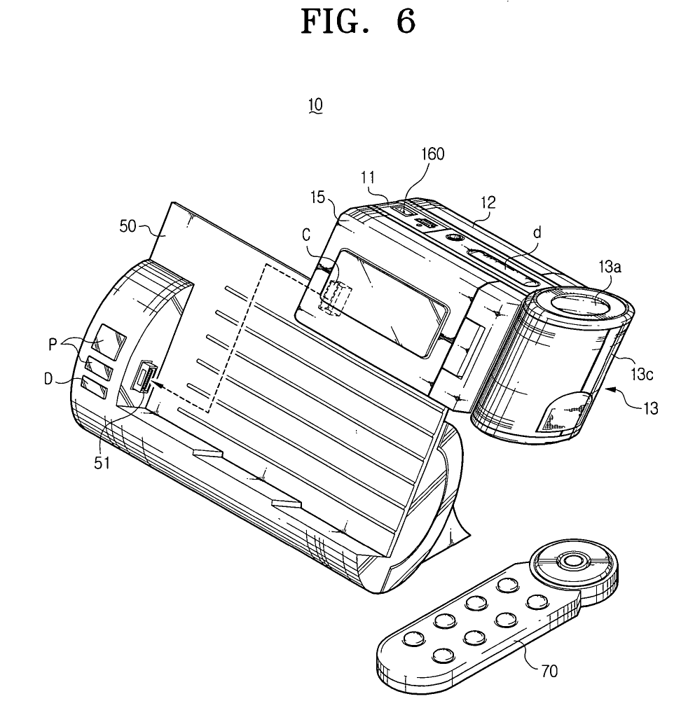

FIG. 6 is a perspective appearance view of a video/audio data recording/reproducing apparatus, according to another embodiment of the present invention and FIG. 7 is a rear perspective view of the apparatus shown in FIG. 6. Referring to FIGS. 6 and 7, according to another embodiment of the present invention, the body 11 of the video/audio recording/reproducing apparatus as described above with reference to FIGS. 1 through 5B is connectable with external data processors or apparatuses, such as a TV set, an audio set, etc., for signal transmission/reception, battery recharging, etc. For example, as shown in FIG. 6, a station 50 receives the body 11. The station 50 is provided with a connection terminal 51 for being connected with a connector C provided at a side of the body 11 during the mounting of the body 11. The battery 30 (FIG. 3) can be connected to the station 50 for power recharge. In FIG. 7, a battery recharging unit (battery charger) 52 recharges the battery 30.

With reference to FIG. 6, in addition to enabling charging of the battery 30 on the body 11 seated on the station 50 with an external power, the connection terminal 51 also functions as a signal transmission/reception terminal that enables transmission/reception of signals driving the body 11 between the body 11 and the station 50. In FIG. 7, general connectors 50a, 50b, 50c, 50d, 50e, such as an SVHS terminal, an AV terminal, connect an external data processor and the station 50. The connectors are connected to the connection terminal 51 of the station 50 for signal transmission/reception. Accordingly, when the body 11 is mounted on the station 50, signal transmission/reception with the external data processors is possible.

In FIG. 6, a series of manipulation buttons realize general functions to drive (control) the body 11 while the body 11 is seated on the station 50. The manipulation buttons P are connected with the connection terminal 51 for signal transmission/reception, and thus it is possible to control the driving of the body 11 through the manipulating the buttons P. The manipulation buttons P may be positioned between the station 50 and the body 11 seated on the station 50 as shown in FIGS. 6 and 7, so that the manipulation buttons P can provide the functions that cannot be externally operated when the body 11 is seated on the station 50, such as the mode shifting switch M, or the sound volume adjusting dial switch V.

In FIG. 6, the signal reception units D and d, provided respectively in the station 50 and at the body 11, receive operation signals from a remote controller 70. The signal reception unit D is connected with the connection terminal 51 of the station 50 for signal transmission/reception, so that when the body 11 is mounted on the station 50, the body 11 can be remotely driven (controlled) through manipulation of the remote controller 70.

FIG. 8 is a functional block diagram of the video/audio data recording/reproducing apparatuses shown in FIGS. 1 and 7, according to an embodiment of the present invention. Referring to FIG. 8, the video/audio data recording/reproducing apparatus comprises a CCD (charge coupled device) 100, an LCD driver 105, an NT/PAL encoder 110, an NT/PAL decoder 115, a TG/CDS/AGC (timing generation/correlated double sampler/auto gain control) 120, a lens driver 125, a mode control unit 130, a V.driver 135, a function block unit 140, a flash memory 145, a power supply 150, an audio interface 155, a USB unit 160, a TIC (transition IC) 165, an HDD (hard disc drive) 170, an SDRAM (synchronous dynamic random access memory) 175 and a control unit 200.

As described above, the CCD 100 converts the optical image input through the lens 13a into electric signals and outputs the electrical signals to the TG/CDS/AGC 120. In other words, the optical image of the object is focused on the photosensitive surface of the CCD 100 by the photography lens 13a, and the CCD 100 converts the image on the photosensitive surface into an electric signal and outputs the electric signal as a 1-dimensional electric signal through horizontal and vertical scanning.

The LCD driver 105 drives (controls) the LCD monitor 13 of the display unit 15. The NT/PAL encoder 110 converts a signal output from the control unit 200 into a video signal according to the NTSC (National television system committee) scheme or the PAL (Phase alternation line) scheme, and outputs the resultant signal to an output terminal, such as one of the general connectors 50a-50e. The NT/PAL decoder 115 converts the NTSC or PAL signals input through the video line input terminal into digital data, and transmits the converted data to the control unit 200. Both the NTSC and the PAL are standard television outputting schemes, and the NTSC is more popular in Korea while PAL is more popular in the European countries.

The TG/CDS/AGC 120 removes noise from the CCD 100 signal by using a correlated double sampling circuit, and transmits the signal, which has passed an auto gain control circuit, to the control unit 200. The lens driver 125 controls a lens driving circuit of the lens 13a to adjust various factors, such as focal point and openness, of the aperture to a desirable degree for photographing. The V.driver 135 refers to a vertical driver of the CCD 100, and the mode control unit 130 controls the LCD driver 105, the lens driver 125 and the V.driver 135 according to a mode selected by the user.

The function block unit 140 stores the operation information about the operation selected by the user by manipulating the manipulating buttons of the apparatus 10, such as the manipulation buttons B and P, and sends the operation information to the mode control unit 130 so that the video/audio data recording/reproducing apparatus 10 is driven in correspondence to the operation information as selected.

The flash memory 145 stores programs, such as a system program necessary for the booting program and the apparatus operation, critical data which have to be maintained even after a power-off, and application programs. The power supply 150 supplies power for the operation of the apparatus 10. The audio interface 155 performs interfacing for the input/output of the external audio signals, and drives the audio equipments, such as a headphone and a microphone. The USB (universal serial bus) 160 is a serial port providing an external computer (computing device), an audio player, and a printer, with a plug-and-play interface.

The TIC (transition IC) 165 matches a signal between the control unit 200 and the HDD 170, and the HDD 170 stores data which are compressed by the control unit 200. As for the HDD 170, typically, a 1-inch hard disc drive is used for the compactness of the apparatus 10. The SDRAM 175 serves as a buffer where necessary data for operating the apparatus 10 are stored.

The control unit 200 performs signal conversion, such as AND conversion with respect to the input signal from the TG/CDS/AGC 120, and from the NT/PAL decoder 115 (i.e., signals input from the video line input). The control unit 200 compresses the converted data input from the TG/CDS/AGC 120 and the NT/PAL decoder 115, the audio interface 155 and the USB 160, and stores the compressed data in the HDD 170 through the TIC 165. A memory stick may be used as a storage medium instead of the HDD 170. During reproducing, the control unit 200 reads the data stored in the HDD 170 and outputs the read data, for example, to the NT/PAL encoder 110 or to the audio interface 155. The control unit 200 also controls other general operations of the apparatus 10.

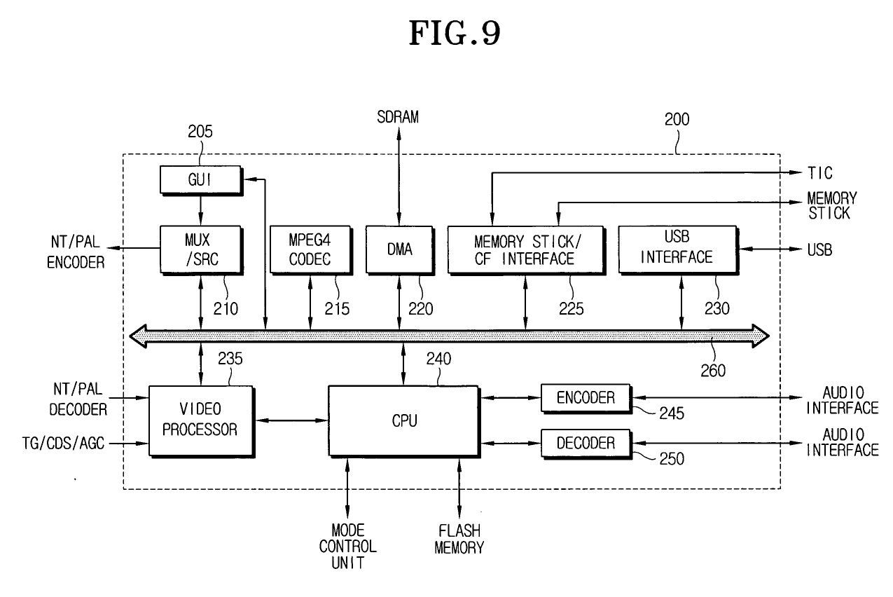

FIG. 9 is a detailed functional block diagram of the control unit 200 of FIG. 8. Referring to FIG. 9, the control unit 200 comprises a GUI 205, a MUX/SRC (multiplexer/system resource controller) 210, a MPEG4 (Motion picture experts group 4) CODEC (compressor/decompressor) 215, a DMA 220, a memory stick/CF interface 225, a USB interface 230, a video processor 235, a CPU 240, an audio encoder 245, an audio decoder 250 and a system bus 260, all of which are preferably integrated into a single chip to enable compactness of the video/audio data recording/reproducing apparatus. The GUI 205 stores data, such as graphic data required for establishment of the GUI (Graphical user interface) environment, and the MUX/SRC 210 controls the data output to the NT/PAL encoder 110, and, if necessary, may output the data mixed with the data stored in the GUI 205.

The MPEG4 CODEC 215 compresses the incoming data in the MPEG4 scheme, and, if necessary, re-extends the compressed data. The MPEG4 is an AN (AudioNideo) standard coding scheme which enables easy data transmission with the communication media of narrow bandwidth and bidirectional multimedia communication. The MPEG4 codes video signals based on the content of the video instead of using block-wise coding in the H.261, JPEG, MPEG1 and MPEG2.

The USB interface 230 interfaces with the USB unit 160. The video processor 235 performs signal conversion, such as the A/D conversion with respect to the incoming signals from the TG/CDS/AGC 120, and transmits to the system bus 260 one of the converted data and the data input through the NT/PAL decoder 115. The audio encoder 245 and the audio decoder 250, respectively, perform encoding and decoding necessary for the data transmission/reception of the audio interface 155. The GUI 205, the MUX/SRC 210, the MPEG4 CODEC 215, the DMA 220, the memory stick/CF interface 225, the USB interface 230, the video processor 235 and the CPU 240 are connected through the system bus 260, and the CPU 240 controls the overall operation of the control unit 200. For compactness, typically, the control unit 200 is formed as a single chip.

Accordingly, the video/audio data recording/reproducing apparatus of the present invention can efficiently perform various functions, and the following description is about the apparatus 10 operating as a digital camcorder. The data captured through the lens 13a is photoelectrically converted by the CCD 110 and transmitted to the control unit 200 via the TG/CDS/AGC 120. The video processor 235 of the control unit 200 converts the incoming analog video signal into digital data, and transmits the digital data to the MPEG4 CODEC 215 through the system bus 260. The MPEG4 CODEC 215 compresses the received digital data in MPEG4 scheme, and transmits the compressed data to the memory stick/CF interface 225. The memory stick/CF interface 225 stores the received compressed data in the HDD 170 through the TIC 165. As a result, images of the object are recorded.

On reproduction, the compressed data, being stored in the HDD 170, is provided to the MPEG4 CODEC 215 by the memory stick/CF interface 225 via the TIC 165 and transmitted to the NT/PAL encoder 110 through the MUX/SRC 210. The NT/PAL encoder 110 displays the received signals on the LCD monitor 13 mounted on the body 11 through the LCD driver 105. Further, the images captured may be displayed through an external display device by transmitting the signals to the TV or an S-JACK (super JACK) terminal, such as the general connectors 50a-50e (FIG. 7). Accordingly, the captured motion pictures or still images are reproduced.

Input through the external video line is transmitted to the control unit 200 through the NT/PAL decoder 115, and compressed and stored in the HDD 170 through the above-described processes. When necessary, the data can be read from the HDD 170 and reproduced. Therefore, the contents displayed through the TV may be recorded and reproduced by the apparatus 10, because the HDD 170 provides a high data storage capacity. Further, it is possible to display the images of the object of the current shooting without having data compression, i.e., by directly outputting the data captured through the lens 13a to the NT/PAL encoder 110.

Meanwhile, in the video/audio data recording/reproducing apparatus 10 operating as a voice recorder or an MP3 player, audio data input through the audio interface 155 is compressed at the MPEG4 CODEC 215 and stored in the HDD 170 through the TIC 165 or in the memory stick. The audio signal stored in the storage mediums, such as the HDD 170 is provided to the MPEG4 CODEC 215 by the memory stick/CF interface 225 via the TIC 165 and transmitted through the audio interface 155 to the headphone, or another external audio device.

The video/audio data recording/reproducing apparatus may also be connected to an external computer through the USB unit 160, to receive necessary data or transmit data to the external computer. Accordingly, the HDD 170, by providing a high storage capacity, allows the video/audio data recording/reproducing apparatus to operate as a data storage device. The video/audio data recording/reproducing apparatus may be also used for other functions, such as a web camera if connection to the computer with the USB unit 160.

As described above, the video/audio data recording/reproducing apparatus according to the present invention can serve various functions, such as the functions of a camcorder, a digital camera, a voice recorder, an MP3 player, a data storage device and a web camera, and many others in various fields. Because the video/audio data recording/reproducing apparatus can be provided as a single package of video and image data processors, such as a camcorder processor and a digital camera processor, along with audio data processors, such as an MP3 player and a voice recorder, compactness is achieved. In particular, the video/audio data recording/reproducing apparatus of the present invention can serve various functions at an economic cost.

Accordingly, the present invention provides in an apparatus an apparatus controller constructed as a single chip and controlling data processing among various data processors implementing various apparatus functions and a micro-compact HDD, thereby providing users (customers) a more compact-sized, an easy to carry, and a more multi-function apparatus. Furthermore, the video/audio data recording/reproducing apparatus can be used not only portably, but also as a stationary set when including the station. More particularly, the present invention provides a video/audio data recording/reproducing apparatus comprising a body having a control unit, at least one data recording medium and a battery, a camera unit provided at a side of the body, a display unit variable in position with respect to the body, and an audio data processing unit. The control unit controls various product units of the apparatus and a micro-compact hard disc drive is a main data recording medium, allowing integration into a single package (apparatus) features of the various product units, such as a digital camcorder, a digital still camera, video recorder/reproducer, a data storage, an MP3 player and a voice recorder. Typically, the control unit is a single chip. Therefore, the video/audio data recording/reproducing apparatus is a compact-sized, portable product, realizing various video/audio data recording/reproducing functions. The present invention as embodied in the control unit 200 may be implemented in computing hardware and/or software.

Although a few embodiments of the present invention have been described, it will be understood by those skilled in the art that the present invention should not be limited to the described embodiments, but various changes and modifications can be made within the spirit and scope of the present invention as defined by the appended claims and their equivalents.

What is claimed is:

1. A video/audio data recording/reproducing apparatus, comprising:
a single chip controller controlling processing by at least two various function units as a digital camcorder, a digital still camera, a video recorder/reproducer, a data storage, an MP3 player and a voice recorder; and
a micro-compact hard disc drive as a main data recording medium storing data of the various function units.

2. The apparatus of claim 1, wherein the controller comprises:
a system bus;
a multiplexer/system resource controller in communication with the system bus and outputting image signals;
a motion picture experts group 4 compressor/decompressor in communication with the system bus and compressing/decompressing data of the function units;
a data recording medium interface in communication with the system bus and reading/writing data from/to a memory unit and the micro-compact hard disc drive;
a universal serial bus interface in communication with the system bus and receiving/transmitting the data of the function units;
a video processor in communication with the system bus and processing image signals input through the digital camcorder and still camera function units or input through an input terminal;
an audio encoder/decoder in communication with the system bus and processing input/output audio signals for the MP3 player and the voice recorder; and
a central processing unit controlling the controller via the system bus.

3. The apparatus of claim 1, further comprising a mode shifting switch selecting the function units.

4. The apparatus of claim 1, further comprising a transient integrated circuit interfacing the micro-compact hard-disk drive with the controller.

5. The apparatus of claim 1, further comprising:
a body including the single chip controller and the micro-compact hard disk drive; and
a station communicatively receiving the body and providing a plurality of transmission/reception terminals allowing data transmission/reception between the body and external computing devices.

6. The apparatus of claim 5, wherein the station and the body are communicatively connected via a connection terminal in the station and the body, respectively.

7. The apparatus of claim 5, wherein the station comprises manipulation buttons controlling the function units while the body is seated on the station.

8. The apparatus of claim 5, wherein the body further comprises a battery and the station recharges the battery power from an external power supply while the body is seated on the station.

9. The apparatus of claim 5, wherein the station comprises an SVHS, an AV, and a video line input as the transmission/reception terminals.

10. The apparatus of claim 5, wherein the station comprises a signal reception unit receiving operations signals from a remote controller to control the function units while the body is seated on the station.

11. The apparatus of claim 5, further comprising a removable storage, wherein the body further comprises a window to check the removable storage connection.

12. The apparatus of claim 1, further comprising a video line input, wherein the controller receives image signals from the video line input, digitizes and compresses the image signals and stores the image signals in the micro-compact hard disc drive, thereby providing a video recorder as one of the various function units.

13. The apparatus of claim 12, further comprising a display unit displaying an image, wherein the controller reads the image signals from the micro-compact hard disc drive, decompresses the read image signals and outputs the decompressed image signals to the display unit for displaying, thereby providing a video reproducer as another function unit.

14. A video/audio data recording/reproducing apparatus, comprising:
a first housing having a receiving area facing inside of the apparatus and accommodating a hard disc drive and a circuit board;
a second housing in a parallel relation facing the receiving area of the first housing; and
a middle housing having a camera zoom button housing and supported in between the first and second housings to support a camera unit at a horizontal axial line of the camera zoom button housing in between the first and second housings.

15. The apparatus of claim 14, wherein the first and second housings each comprises an integral casing area covering the camera unit supported by the middle housing.

16. The apparatus of claim 15, wherein the integral casing areas are concave.

17. The apparatus of claim 16, wherein the camera zoom button housing is round and accommodated by the concave integral casing areas.

18. The apparatus of claim 14, wherein the second housing has a receiving area facing outside of the apparatus to receive a battery.

19. The apparatus of claim 14, wherein the middle housing has a through opening to receive therein the circuit board.

20. The apparatus of claim 18, further comprising a cover removably mounted on the second housing receiving area.

21. The apparatus of claim 14,
wherein the middle housing is rectangular having two vertical side surfaces and at least one bottom horizontal surface and a through opening, and
wherein increasing a width of the vertical and horizontal surfaces increases in the apparatus an interior receiving area comprising the first housing receiving area and the opening of the middle housing.

22. A video/audio data recording/reproducing apparatus, comprising:
a first housing having a receiving area facing inside of the apparatus and accommodating a hard disc drive;
a second housing in a parallel relation facing the receiving area of the first housing and having a receiving area facing outside of the apparatus and accommodating a removable battery; and
a middle housing having a camera zoom button housing and accommodating a circuit board, and supported in between the first and second housings to support a camera unit at a horizontal axial line of the zoom button housing in between the first and second housings.
